(19) United States
(12) Patent Application Publication
(10) Pub. No.: US 2026/0353522 A1
(43) Pub. Date: Nov. 5, 2026

(54) INDUCTION HEATER AND CONTROLLING METHOD THEREOF

(71) Applicant: SAMSUNG ELECTRONICS CO., LTD., Suwon-si (KR)

(72) Inventors: Jaehoon CHA, Suwon-si (KR); Kumchul HWANG, Suwon-si (KR); Dongwook KIM, Suwon-si (KR); Jaehee SHIN, Suwon-si (KR)

(73) Assignee: SAMSUNG ELECTRONICS CO., LTD., Suwon-si (KR)

(21) Appl. No.: 19/715,606

(22) Filed: Jun. 22, 2026

Related U.S. Application Data
(63) Continuation of application No. PCT/KR2024/015256, filed on Oct. 8, 2024.

(30) Foreign Application Priority Data
Jan. 4, 2024 (KR) 10-2024-0001811

(51) Int. Cl. H05B 6/06; H05B 6/12

(52) U.S. Cl. CPC H05B 6/062; H05B 6/1209

(57) ABSTRACT

An induction heater includes: a plate on which a cooking vessel is placeable; a vibration sensor configured to detect vibration intensity of the cooking vessel while the cooking vessel is placed on the plate; a heating coil configured to heat the cooking vessel; and a controller configured to: control the heating coil to heat the cooking vessel, obtain a first vibration pattern of the cooking vessel based on vibration data obtained through the vibration sensor, based on the first vibration pattern satisfying a first condition, decrease power level of the heating coil and maintain the decreased power level for a defined time, obtain a second vibration pattern of the cooking vessel after the defined time lapses, and based on the second vibration pattern satisfying a second condition, determine content of the cooking vessel is in a boiling state.

### CROSS-REFERENCE TO RELATED APPLICATION

This application is a continuation application, under 35 U.S.C. § 111(a), of international application No. PCT/KR 2024/015256, filed Oct. 8, 2024, which claims priority under 35 U.S. C. § 119 to Korean Patent Application No. 10-2024-0001811, filed Jan. 4, 2024, the disclosures of which are incorporated herein by reference in their entireties.

### TECHNICAL FIELD

The disclosure relates to an induction heater and a method for controlling the same, and more particularly, to an induction heater including a heating coil and a method for controlling the same.

### BACKGROUND ART

In general, an induction heater is a cooking apparatus that heats and cooks food using the principle of induction heating. The induction heater may include a cooking plate on which a cooking vessel is placed, and a heating coil that generates a magnetic field when an electric current is applied.

When current is applied to the heating coil and a magnetic field is generated, a secondary current is induced in the cooking vessel, and Joule heat is generated by an electrical resistance component of the cooking vessel itself. As a result, the cooking vessel is heated by a high frequency current, and the food in the cooking vessel is cooked.

Because an induction heater uses a cooking vessel itself as a heat source, induction heaters have higher heat transfer rates, no harmful gases, and no risk of fire, compared to gas stoves or kerosene stoves that burn fossil fuels and heat the cooking vessel through the heat of combustion.

In existing technologies, in order to detect the boiling of water in a cooking vessel, the vibration of the cooking vessel containing the water was detected.

However, in an actual use of an induction heater, because various vibrations exist, only the vibration related to the boiling of water is not easily detected and the detection of boiling water is inaccurate. In addition, the types of vessels that could be used to detect boiling using vibration are limited. For example, only cooking vessels coated with a thin glass-ceramic layer on a metal base could be used, and commonly used cooking vessels, such as ceramic-coated, cast iron, and non-stick cooking vessels, could not be used.

### DISCLOSURE

### Technical Problem

The disclosure provides an induction heater that may more accurately and reliably detect whether food contained in a cooking vessel is boiling regardless of the type of the cooking vessel.

Technical aspects that can be achieved by the disclosure are not limited to the above-mentioned aspects, and other technical aspects not mentioned will be clearly understood by one of ordinary skill in the technical art to which the disclosure belongs from the following description.

### Technical Solution

According to an aspect of the disclosure, an induction heater may include: a plate on which a cooking vessel is placeable; a vibration sensor configured to detect vibration intensity of the cooking vessel while the cooking vessel is placed on the plate; a heating coil configured to heat the cooking vessel; and a controller configured to: control the heating coil to heat the cooking vessel, obtain a first vibration pattern of the cooking vessel based on vibration data obtained through the vibration sensor, based on the first vibration pattern satisfying a first condition, decrease power level of the heating coil and maintain the decreased power level for a defined time, obtain a second vibration pattern of the cooking vessel after the defined time lapses, and based on the second vibration pattern satisfying a second condition, determine content of the cooking vessel is in a boiling state.

According to an aspect of the disclosure, in a method of controlling an induction heater where the method may include: controlling a heating coil configured to heat a cooking vessel; obtaining a first vibration pattern of the cooking vessel based on vibration data of the cooking vessel obtained through a vibration sensor configured to detect vibration intensity of the cooking vessel while the cooking vessel is placed on a plate of the induction heater; based on the first vibration pattern satisfying a first condition, decreasing power level of the heating coil and maintaining the decreased power level for a defined time; obtaining a second vibration pattern of the cooking vessel after the defined time lapses; and based on the second vibration pattern satisfying a second condition, determining content of the cooking vessel is in a boiling state.

### DESCRIPTION OF DRAWINGS

FIG. 1 illustrates an exterior of an induction heater according to an embodiment.

FIG. 2 and FIG. 3 are views illustrating a heating principle of an induction heater according to an embodiment.

FIG. 4 illustrates an example of a resonance circuit of an induction heater according to an embodiment.

FIG. 5 is a control block diagram of an induction heater according to an embodiment.

FIG. 6 is a flowchart illustrating a method for controlling an induction heater according to an embodiment.

FIG. 7 is a detailed flowchart illustrating a method for controlling an induction heater according to an embodiment.

FIG. 8 is a graph illustrating a change in vibration intensity during a boiling process of water in a cooking vessel on an induction heater according to an embodiment.

FIG. 9 is a graph illustrating an example of vibration intensity over time during a boiling process of water in a cooking vessel on an induction heater according to an embodiment.

FIG. 10 is a graph illustrating another example of vibration intensity over time during a boiling process of water in a cooking vessel on an induction heater according to an embodiment.

FIG. 11 is a graph illustrating still another example of vibration intensity over time during a boiling process of water in a cooking vessel on an induction heater according to an embodiment.

FIG. 12 is a graph illustrating a local maximum value of vibration intensity over time in a boiling process of food in a cooking vessel on an induction heater according to an embodiment.

FIG. 13 is a graph illustrating an example of detecting a local maximum value of vibration intensity over time during a boiling process of water in a cooking vessel on an induction heater according to an embodiment.

FIG. 14 is a graph illustrating another example of detecting a local maximum value of vibration intensity over time during a boiling process of water in a cooking vessel on an induction heater according to an embodiment.

FIG. 15 is a graph illustrating still another example of detecting a local maximum value of vibration intensity over time during a boiling process of water in a cooking vessel on an induction heater according to an embodiment.

### MODES OF THE INVENTION

Various embodiments and the terms used therein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Hereinafter, embodiments of the disclosure will be described with reference to accompanying drawings.

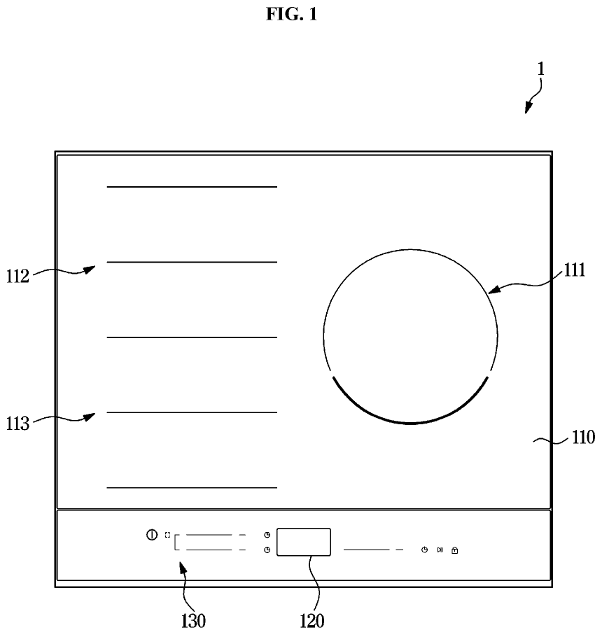

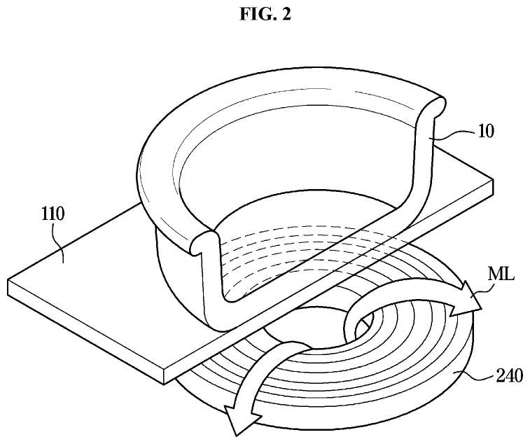

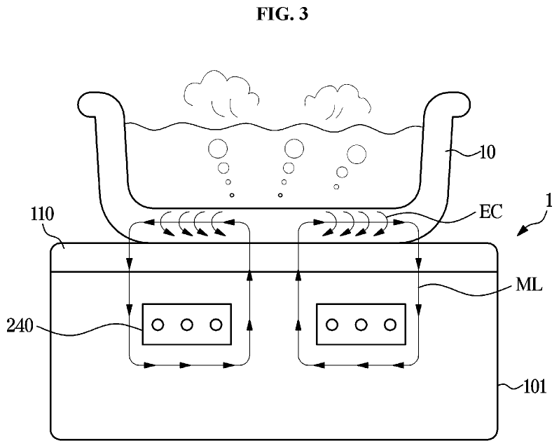

FIG. 1 illustrates an exterior of an induction heater according to an embodiment, and FIG. 2 and FIG. 3 are views illustrating a heating principle of an induction heater according to an embodiment.

FIG. 1 is a view of an induction heater 1 according to an embodiment as viewed from above. As shown in FIG. 1, the induction heater 1 according to an embodiment may include a plate 110 provided above a main body 101, cooking zones 111, 112, and 113 formed on the plate 110, and user interfaces 120 and 130 functioning as input/output devices. For example, the plate 110 may be made of ceramic.

The cooking zones 111, 112, and 113 indicate positions on which cooking vessels are placed, and may be represented as a circular shape as indicated by a reference numeral 111 or as straight boundary lines as indicated by reference numerals 112 and 113 to guide proper placement of the cooking vessels.

However, the above-described shapes are only examples of shapes for representing the cooking zones 111, 112, and 113, and any shape may be applied to embodiments of the induction heater 1 as long as it may guide a user to the location of the cooking zone.

In addition, although it is illustrated in FIG. 1 that three cooking zones are formed on the plate 110 as an example, the embodiment of the induction heater 1 is not limited thereto. That is, only one cooking zone or four or more cooking zones may be formed.

In one region on the plate 110, a display 120 and an input device 130 may be provided. The display 120 may include a display device, such as a liquid crystal display (LCD) or a light-emitting diode (LED), and the input device 130 may include at least one of various input devices, such as a touch pad, a button, or a jog shuttle. Alternatively, the display 120 and the input device 130 may be implemented as a touch screen.

It is illustrated that the display 120 and the input device 130 are spaced apart from the cooking zones 111, 112, and 113 on the plate 110. However, the arrangement of FIG. 1 is only an example, and the display 120 or the input device 130 may be located other than the plate 110, such as on the front of the cooking apparatus (induction heater) 100.

Referring to FIG. 2 and FIG. 3 together, a heating coil 240 used to heat a cooking vessel 10 placed on the plate 110 may be disposed below the plate 110. For convenience of description, only one heating coil 240 is illustrated in FIG. 2 and FIG. 3, but the heating coil 240 may be provided corresponding in number to the number of cooking zones.

In a case where three cooking zones 111, 112, and 113 are provided as shown in the example of FIG. 1, three heating coils 240 may also be provided, and each of the heating coils 240 may be disposed below a corresponding one of the cooking zones 111, 112, and 113.

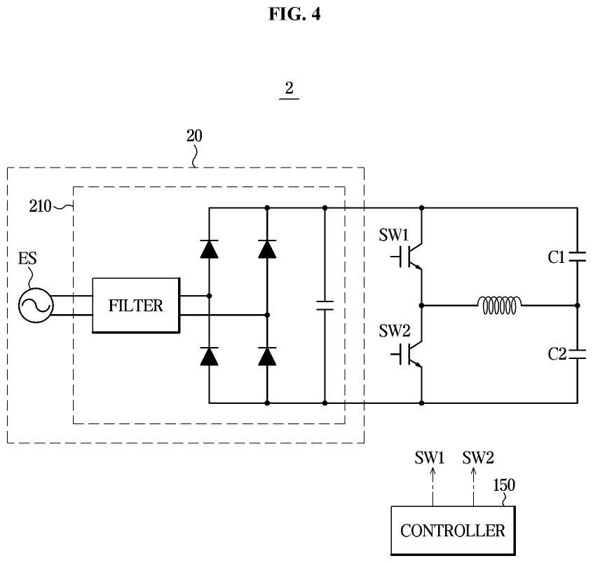

The heating coil 240 may be connected to a resonance circuit 2 (see FIG. 4) to be described below, and a high frequency current may be applied from the resonance circuit 2. For example, the frequency of the high frequency current may be 20 kHz to 35 kHz.

When the heating coil 240 is supplied with a high frequency current, magnetic force lines ML may be formed in the heating coil 240. In a case where the cooking vessel 10 having resistance is located within a range where the magnetic force lines ML reach, the magnetic force lines ML around the heating coil 240 pass through the bottom of the cooking vessel 10, generating an induced current in the form of a vortex according to the law of electromagnetic induction, i.e., eddy currents (EC).

The eddy current EC may interact with the electrical resistance of the cooking vessel 10, generating heat in or on the cooking vessel 10, and the generated heat may heat the food inside the cooking vessel 10.

In the induction heater 1, the cooking vessel 10 itself acts as a heat source, and a metal having a resistance of a defined level or higher, such as iron, stainless steel, or nickel, may be used as a material of the cooking vessel 10.

Meanwhile, the specifications of the heating coil 240 may differ according to the rated voltage of the country where the induction heater 1 is sold.

FIG. 4 illustrates an example of a resonance circuit of an induction heater according to an embodiment.

Referring to FIG. 4, the resonance circuit 2 may include a power supply section 20.

The power supply section 20 may include a power source ES and a rectifier 210.

The power source ES is an alternating current (AC) power source ES, and may supply the power source ES corresponding to the rated voltage.

The rectifier 210 may convert an AC voltage supplied from the power source ES into a direct current (DC) voltage.

To this end, the rectifier 210 may include a bridge rectifier circuit including a plurality of diodes. For example, the bridge rectifier circuit may include four diodes. The diodes form diode pairs in which two diodes are connected in series, and the two diode pairs may be connected in parallel with each other. The bridge diode may convert an AC voltage whose polarity changes with time into a voltage whose polarity is constant, and may convert an AC current whose direction changes with time into a current whose direction is constant.

In addition, the rectifier 210 may include a DC link capacitor. The DC link capacitor may convert a voltage whose magnitude changes with time into a DC voltage of a constant magnitude. The DC link capacitor may maintain the converted DC voltage and provide the converted DC voltage to inverters SW1 and SW2. In this instance, the inverters SW1 and SW2 may include a first switching element SW1 and a second switching element SW2.

The first switching element SW1 and the second switching element SW2 operate in a complementary manner, thereby allowing an AC current to flow through the heating coil 240.

The first switching element SW1 and the second switching element SW1 may be implemented as a three-terminal semiconductor device switch having a fast response speed in order to be turned on/off at high speed. For example, the first switching element SW1 and the second switching element SW1 may be a bipolar junction transistor (BJT), a metal-oxide-semiconductor field effect transistor (MOSFET), an insulated gate bipolar transistor (IGBT), or a thyristor.

The first switching element SW1 and the second switching element SW2 may be turned on/off by a switch driving signal. In this instance, the switch driving signal may be provided by a controller 150, and the controller 150 may supply a high frequency AC current to the heating coil 240 by alternately turning on/off the first switching element SW1 and the second switching element SW2.

According to various embodiments, the resonance circuit 2 may further include a filter for removing noise components included in the power supplied from the power source ES. The filter may include a transformer and a capacitor to remove noise mixed into the power supplied from the power source ES, and may provide the AC power from which noise is removed to the rectifier 210.

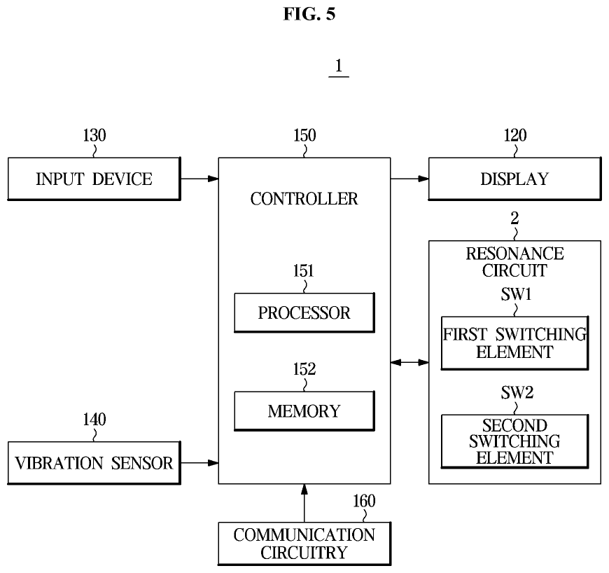

FIG. 5 is a block diagram illustrating a configuration of an induction heater according to an embodiment.

Referring to FIG. 5, the induction heater 1 according to an embodiment may include the display 120, the input device 130, a vibration sensor 140, the controller 150, communication circuitry 160, and the resonance circuit 2.

The resonance circuit 2 may include the first switching element SW1 and the second switching element SW2 which are inverters SW1 and SW2.

The display 120 may display information about a current state of the induction heater 1, information for guiding selection of a cooking zone or selection of a power level, and information for guiding setting of a timer. In addition, a notification indicating the presence or absence of the cooking vessel 10 may be displayed.

The input device 130 may receive a selection command for a power level of the heating coil 240 from a user. In response to receiving the selection command for the power level of the heating coil 240 from the user through the input device 130, the controller 150 may determine ON/OFF frequencies of the first switching element SW1 and the second switching element SW2 based on the selected power level. The controller 150 may apply a high frequency current of a frequency corresponding to the selected power level to the heating coil 240 by alternately turning on/off the first switching element SW1 and the second switching element SW2 according to the determined ON/OFF frequencies.

The vibration sensor 140 may detect vibration of the cooking vessel 10.

The vibration sensor 140 may detect the vibration of the cooking vessel 10 via the plate 110.

The vibration sensor 140 may be provided on the plate 110 on which the cooking vessel 10 is placed, and may detect the vibration of the plate 110 corresponding to the vibration of the cooking vessel 10.

When the food in the cooking vessel 10 placed on the plate 110 is heated, a flow of the food may occur. Such a flow of the food may physically affect the cooking vessel 10 to generate vibration. This vibration of the cooking vessel 10 may be transmitted to the plate 110 on which the cooking vessel 10 is placed. The vibration sensor 140 may detect a vibration pattern of the cooking vessel 10 via the plate 110 by detecting the vibration of the plate 110. Accordingly, whether the food contained in the cooking vessel 10 is boiling may be determined by analyzing the vibration pattern of the cooking vessel 10 generated while the food boils.

The vibration sensor 140 may detect at least one of an X-axis acceleration, a Y-axis acceleration, or a Z-axis acceleration of the cooking vessel 10.

The vibration sensor 140 may be a 1-axis acceleration sensor that detects one of the X-axis acceleration, the Y-axis acceleration, or the Z-axis acceleration of the cooking vessel 10.

The vibration sensor 140 may be a 2-axis acceleration sensor that detects two of the X-axis acceleration, the Y-axis acceleration, or the Z-axis acceleration of the cooking vessel 10.

The vibration sensor 140 may be a 3-axis acceleration sensor or a 3-axis micro electro mechanical system (MEMS) sensor that detects all of the X-axis acceleration, the Y-axis acceleration, and the Z-axis acceleration of the cooking vessel 10.

The vibration sensor 140 may collect sensor data about the vibration of the cooking vessel 10. For example, the vibration sensor 140 may obtain the acceleration of an axis corresponding to the vibration of the cooking vessel 10.

In an embodiment, the controller 150 may obtain at least one of the X-axis acceleration, the Y-axis acceleration, or the Z-axis acceleration of the cooking vessel 10 based on vibration data which is an output value of the vibration sensor 140. The controller 150 may obtain an acceleration of at least one axis of the cooking vessel 10 based on processing the vibration data of the vibration sensor 140. For example, the controller 150 may obtain at least one of the X-axis acceleration, the Y-axis acceleration, or the Z-axis acceleration of the cooking vessel 10 based on the vibration data of the vibration sensor 140.

The communication circuitry 160 may include at least one of a short-range wireless communication module or a long-range wireless communication module.

The communication circuitry 160 may transmit data to an external device or receive data from an external device. For example, the communication circuitry 160 may establish communication with a server, a user device, and/or other home appliances, and may transmit and receive various data.

To this end, the communication circuitry 160 may support establishment of a direct wired communication channel or a wireless communication channel between external devices, and may support communication through the established communication channel. According to an embodiment, the communication circuitry 160 may include a wireless communication module (e.g., a cellular communication module, a short-range wireless communication module, or a global navigation satellite system (GNSS) communication module) or a wired communication module (e.g., a local area network (LAN) communication module or a power line communication module). Among these communication modules, a corresponding communication module may communicate with an external device through a first network (e.g., a short-range communication network like Bluetooth, wireless fidelity (Wi-Fi) direct, or infrared data association (IrDA)) or a second network (e.g., a long-range communication network like a legacy cellular network, a 5G network, a next-generation communication network, the Internet, or a computer network such as LAN or wide area network (WAN)). These various types of communication modules may be implemented as one component (e.g., a single chip) or implemented as a plurality of separate components (e.g., a plurality of chips).

The short-range wireless communication module may include a Bluetooth communication module, a Bluetooth Low Energy (BLE) communication module, a near field communication module, a WLAN (Wi-Fi) communication module, a Zigbee communication module, an infrared data association (IrDA) communication module, a Wi-Fi Direct (WFD) communication module, an ultrawideband (UWB) communication module, an Ant+communication module, a microwave (uWave) communication module, and the like, but is not limited thereto.

The long-range wireless communication module may include a communication module that performs various types of long-range wireless communication, and may include mobile communication circuitry. The mobile communication circuitry transmits and receives radio signals to and from at least one of a base station, an external terminal, or a server on a mobile communication network.

In an embodiment, the communication circuitry 160 may communicate with an external device such as a server, a user device, or another home appliance through a nearby access point (AP). The access point (AP) may connect a local area network (LAN) to which the induction heater 1, the other home appliance, and/or the user device are connected to a wide area network (WAN) to which a server is connected. The induction heater 1, the other home appliance, and/or the user device may be connected to the server through the wide area network (WAN).

The controller 150 may control operation of the induction heater 1.

The controller 150 may include at least one memory 152 in which a program for performing an operation to be described below is stored, and at least one processor 151 that executes the stored program.

The at least one processor 151 may include a microprocessor. The microprocessor is a processing device in which components such as an arithmetic logic unit, a register, a program counter, an instruction decoder, or a control circuit are integrated on at least one silicon chip.

The microprocessor may include a graphic processing unit (GPU) for graphic processing of images or videos. The microprocessor may be implemented as a system-on-chip (SoC) including a core and a GPU. The microprocessor may include a single core, a dual core, a triple core, a quad core, and a core of multiples thereof.

In addition, the at least one processor 151 may include an input/output processor to mediate data access between various components included in the induction heater 1 and the controller 150.

The at least one memory 152 may include a non-volatile memory such as a read only memory (ROM), a high-speed random access memory (RAM), a magnetic disk storage device, a flash memory device, or other types of non-volatile semiconductor memory devices.

For example, the at least one memory 152 may be a semiconductor memory device, including one of a secure digital (SD) memory card, a secure digital high capacity (SDHC) memory card, a mini SD memory card, a mini SDHC memory card, a trans flash (TF) memory card, a micro SD memory card, a micro SDHC memory card, a memory stick, a compact flash (CF), a multi-media card (MMC), an MMC micro, or an eXtreme Digital (XD) card.

In addition, the at least one memory 152 may include a network attached storage device that is accessed through a network.

The controller 150 may control the induction heater 1 based on a user input received through the input device 130. For example, the input device 130 may receive a user input related to power on/off, selection of the cooking zones 111, 112, and 113, selection of the power level of the heating coil 240 of the selected cooking zone, setting of a timer, and the like.

For example, the controller 150 may select the heating coil 240 to be supplied with high frequency power according to a selection of a cooking zone received through the input device 130, and may adjust an intensity of a magnetic field generated by the heating coil 240 according to a selection of the power level received by the input device 130. However, in a case where the induction heater 1 includes a single cooking zone, the power level may be directly selected without selecting a cooking zone.

The controller 150 may increase a power level of the heating coil 240 so that the food contained in the cooking vessel 10 is heated, may obtain a first vibration pattern of the cooking vessel 10 based on vibration data of the vibration sensor 140. Based on the first vibration pattern satisfying a defined first condition, the controller 150 may decrease the power level of the heating coil 240 and maintain the decreased power level for a defined time. The controller 150 may obtain a second vibration pattern of the cooking vessel 10 after the defined time has elapsed, and may determine that the food is in a boiling state based on the second vibration pattern satisfying a defined second condition.

The controller 150 may display a boiling state of the food through the display 120.

Based on the food being in a boiling state, the controller 150 may output a message notifying that the food is boiling, or may display a boiling progress on the display 120.

Based on the food being in a boiling state, the controller 150 may control the communication circuitry 160 to transmit a signal indicating the boiling state of the food to an external device. The external device may include a server, a user device (e.g., a smartphone), other home appliances, and the like.

For example, the signal indicating the boiling state of the food may be transmitted to a user device possessed by a user of the induction heater 1 via a server.

Based on receiving the signal indicating the boiling state of the food, the external device may output sensory information (e.g., an image, vibration, sound, and the like) notifying of the boiling state of the food through the external device's output interface.

For example, in a case where the external device is a smartphone, the smartphone may output a notification message, vibration, and/or sound based on receiving the signal indicating the boiling state of the food.

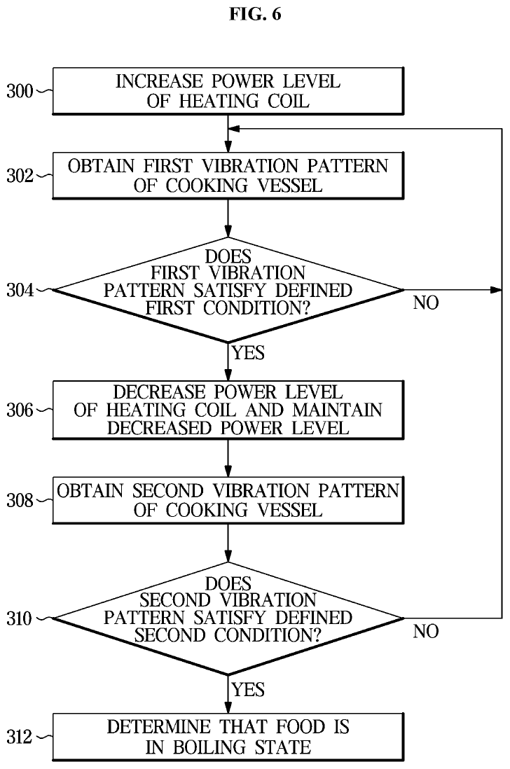

FIG. 6 is a flowchart illustrating a method for controlling an induction heater according to an embodiment.

Referring to FIG. 6, the controller 150 may increase a power level of the heating coil 240 so that the food contained in the cooking vessel 10 is heated (300).

The controller 150 may obtain a first vibration pattern of the cooking vessel 10 based on vibration data of the vibration sensor 140 (302).

The controller 150 may determine whether the first vibration pattern satisfies a defined first condition (304).

The defined first condition is a condition under which the food contained in the cooking vessel 10 is estimated to be in a boiling state as the cooking vessel 10 is heated. For example, the defined first condition may be determined based on a slope of vibration intensity.

Based on the first vibration pattern satisfying the defined first condition, the controller 150 may decrease the power level of the heating coil 240 and maintain the decreased power level for a defined time (306).

The controller 150 may obtain a second vibration pattern of the cooking vessel 10 after the defined time has elapsed (308).

The controller 150 may determine whether the second vibration pattern satisfies a defined second condition (310).

The defined second condition may be a condition in which the food contained in the cooking vessel 10 is confirmed to be in a boiling state. For example, the defined second condition may be determined based on at least one of a vibration intensity or a vibration intensity slope.

Based on the second vibration pattern satisfying the defined second condition, the controller 150 may determine that the food contained in the cooking vessel 10 is in a boiling state (312).

The food may include a liquid component. For example, the food may be stew, soup, porridge, curry, water, and the like.

Hereinafter, for convenience of description, water is described as the food.

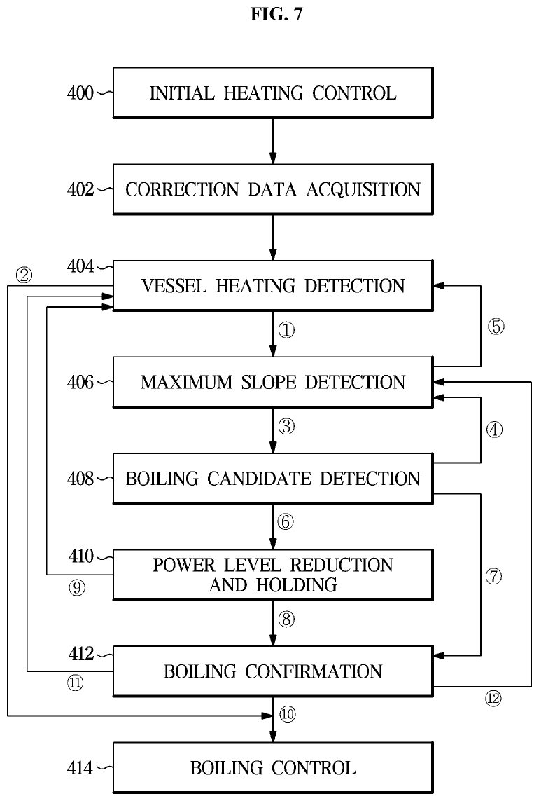

FIG. 7 is a detailed flowchart illustrating a method for controlling an induction heater according to an embodiment.

Referring to FIG. 7, operation stages of the induction heater may be divided into an initial heating control stage (400), a correction data acquisition stage (402), a vessel heating detection stage (404), a maximum slope detection stage (406), a boiling candidate detection stage (408), a power level reduction and holding stage (410), a boiling confirmation stage (412), and a boiling control stage (414).

In the initial heating control stage (400), an operation for stabilizing a vibration state of the induction heater 10 may be performed because whether food is boiling is determined using a vibration pattern of the cooking vessel 10 detected via the plate 110.

The initial heating control stage (400) is a preparation stage for obtaining correction data, and the controller 150 may initially control the inverters SW1 and SW2 and a cooling fan of the induction heater 1. The cooling fan may introduce external air into the induction heater 1 so as to cool internal components of the induction heater 1.

In the initial heating control stage (400), when a temperature of the induction heater 1 increases during a boiling process of water, the cooling fan operates. A rotation speed of the cooling fan may vary according to the internal temperature of the induction heater 1. When the cooling fan operates or the rotation speed of the cooling fan varies, a vibration intensity of the plate 110 of the induction heater 1 may also vary.

When a power level of the heating coil 240 is set, the inverters SW1 and SW2 operate, and vibration may occur. Because this vibration is unrelated to vibration occurring when water boils, this vibration may interfere with detection of water boiling.

Accordingly, although the inverters SW1 and SW2 operate, vibration in a state where water is not boiling may be measured and used for correction. Because correction data is obtained in the subsequent correction data acquisition stage (402), the power level may be controlled to a power level suitable for obtaining correction data.

It may be experimentally confirmed that a main frequency band of vibration occurring when the power level of the heating coil 240 is low is not significantly different from a band when the power level is high.

Accordingly, in the initial heating control stage (400), the power level may be set to a low level to confirm the frequency bands of the inverters SW1 and SW2. The power level may be controlled to a maximum power level at which water does not boil. In general, accuracy of correction may be higher when correction is performed based on the power level at which water is actually boiled. However, when the power level is high in the correction data acquisition stage (402), the accuracy of correction may be lowered due to vibration caused by the cooking vessel 10 being heated or by water evaporating.

For example, in a case of power levels 1 to 9, in the initial heating control stage (400), the power level may be set to a power level 4 (initial power level).

In the initial heating control stage (400), the controller may maintain a waiting state for a preset time to stabilize vibration of the inverters SW1 and SW2 and the cooling fan. For example, the controller may wait for 5 seconds after operating the inverters SW1 and SW2 and the cooling fan.

In the correction data acquisition stage (402), correction data in which a vibration pattern of the cooking vessel 10 is corrected may be obtained by obtaining the vibration pattern and then removing vibration components generated in the induction heater 1 in the initial heating stage (400). That is, the correction data may include vibration components from which the vibration components of the inverters SW1 and SW2 and the cooling fan are removed, i.e., vibration components unrelated to vibration occurring when water boils, from among the vibration patterns of the cooking vessel 10. For reference, correction data may also be used to refer to vibration components of the inverters SW1 and SW2 and the cooling fan that are unrelated to the vibration occurring when water boils.

In the correction data acquisition stage (402), frequencies and intensities mainly occurring in the vibration generated in the inverters SW1 and SW2 and the cooling fan of the induction heater 1 may be used for correction.

In the correction data acquisition stage (402), the power level may be maintained at power level 4, the same as in the initial heating stage (400).

In the correction data acquisition stage (402), the vibration sensor 140 for obtaining the vibration pattern of the cooking vessel 10 may be an accelerometer sensor, and may detect acceleration along an X-axis, a Y-axis, and a Z-axis on the plate 110 when the cooking vessel 10 is heated.

In a case where the vibration sensor 140 detects all of the X-axis, Y-axis, and Z-axis movements on the plate 110, a large amount of calculation is required, and thus the controller 150 may detect only movement along one axis. For example, among the X-axis, Y-axis, and Z-axis movements on the plate 110, only the Z-axis movement may be used for calculation.

The vibration sensor 140 may provide an acceleration value for each axis. The sign of the acceleration value may indirectly indicate a direction of movement. A cycle in which the sign of the acceleration value changes may indicate a cycle of main vibration. Although various vibrations acting on the vibration sensor 140 may interfere with each other to amplify or cancel signals, the cycle in which the sign changes may reflect a vibration cycle of the strongest vibration. A magnitude of the acceleration value may indicate an intensity of vibration. Although the magnitude of the acceleration value is such that signals are amplified or canceled due to interference of various vibrations with each other, as the vibration increases, the magnitude of the sensor value may also increase.

The controller 150 may convert time-axis data received from the vibration sensor 140 for a defined period of time into frequency-axis data through a fast fourier transform (FFT).

For example, FFT may be performed on the 512 pieces of data most recently received, which may indicate that the FFT size is 512.

An FFT size of 512 may be separated into 257 (512/2+1) frequency bands. In a case where 1000 pieces of data are obtained per second from the vibration sensor 140, frequencies up to 500 Hz may be theoretically confirmed.

The FFT may be calculated for the 512 most recent samples at an FFT execution cycle (e.g., 250 ms), and as a result, a magnitude for each of the 257 frequency bands may be obtained.

In the correction data acquisition stage (402), sample data for correction may be obtained. Magnitudes of all frequency bands may be stored over a defined time (e.g., 5 seconds). Then, reference data for correction may be generated through calculation in several subsequent stages.

For example, because the FFT is calculated at a cycle of 250 ms, the FFT may be calculated 20 times (5,000/250) over 5 seconds. Because magnitudes for 257 frequency bands may be obtained for each FFT, a total of 5,140 (20*257) pieces of data may be stored as sample data for correction.

In the correction data acquisition stage (402), after obtaining sample data for correction, a representative value for each frequency band may be determined. For example, because 20 pieces of data for each frequency band are obtained over 5 seconds, each representative value may be determined as an average value or a median value.

For example, a median value may be applied as each representative value. During the 5 seconds of obtaining data, large vibrations may occur due to the surrounding environment. For example, large vibrations may occur due to the surrounding environment, such as placing a lid on the cooking vessel 10, placing a cutting board on a sink, or slamming the door of a nearby refrigerator. These noises (vibrations) produce large spikes in values. Accordingly, a large error may occur when an average value is used, whereas the median value is useful for removing such intermittent noises because the median value excludes spikes.

Under the assumption that sample data for correction is stable in a normal vibration environment, a minimum value or a value close to the minimum value may be used.

In the correction data acquisition stage (402), unnecessary frequency bands may be identified. Frequency bands to be excluded may be identified based on the representative value of respective frequency bands. In general, frequencies of vibrations generated by operation of the cooling fan or the inverters SW1 and SW2 may be excluded. The frequency bands of the two vibrations affect the vibration intensity occurring when water boils. The frequency bands of the two vibrations may be amplified or canceled, which may interfere with determining a trend of water boiling.

Even in a case where a specific frequency exhibits a significant response when water boils, a trend of water boiling may not be easily observed when the specific frequency overlaps with the frequencies of the inverters SW1 and SW2. In order to avoid amplification or cancelation with the external environment, the specific frequency may be ignored (excluded). That is, because the induction heater 1 according to an embodiment is not to intensively identify a specific frequency at which water boils, but to exclude bands that interfere with vibration occurring when water boils in advance and to observe a trend of the remaining bands, the specific frequency band may be identified in the correction data acquisition stage (402).

This may be determined by the following four criteria.

First, 19 low frequency bands may be excluded. For example, a frequency range from the 0 Hz to 35 Hz may be excluded. Experimentally, in this range, a change trend of magnitude may not be clearly observed when water boils. At times, the intensity increased, and at other times, the intensity decreased as the water boiled.

Second, 24 high frequency bands may be excluded. For example, a frequency range from 455 Hz to 500 Hz may be excluded. Experimentally, in this range, a change trend of magnitude may not be clearly observed when water boils.

Third, the top 16 bands with the largest magnitudes may be excluded. The magnitudes of the remaining bands excluding the bands excluded in the first and second criteria may be sorted in descending order, and the top number (e.g., the top 16 bands) may be excluded. This is because a large magnitude in such bands may indicate that an external influence unrelated to water boiling is present.

Fourth, a frequency band where a magnitude drastically increases compared to adjacent bands may be excluded. This may include identifying a frequency band having a relatively large magnitude compared to adjacent bands, even when an absolute magnitude is not large and the band is not excluded according to the third criterion. The large magnitude in such bands may indicate that an external influence unrelated to water boiling is present.

In the correction data acquisition stage (402), correction data may be generated.

When setting the representative value of each frequency band, a median value was calculated to determine the representative value of each band, and the bands to be excluded were determined by the above four criteria. Non-excluded bands and representative values of the bands may be used for correction.

In the vessel heating detection stage (404), whether the cooking vessel 10 has been sufficiently heated may be confirmed.

In the vessel heating detection stage (404), water starts to be heated at a high power level. The power level may be set to 9.

When a temperature of the cooking vessel 10 increases, water in direct contact with the cooking vessel 10 may start to evaporate. As the evaporation of water increases, increasingly stronger vibrations may occur. By detecting such a vibration state using the vibration sensor 140, a heating state of the cooking vessel 10 may be detected.

Before describing the vessel heating detection stage (404) in detail, a method of calculating a reference value of vibration intensity and a method of calculating a slope of vibration intensity are described first.

First, a method of calculating a reference value of vibration intensity is described.

The reference value of vibration intensity may be consistently calculated throughout the water boiling detection algorithm, and may be one of the objects of comparison for stage transition.

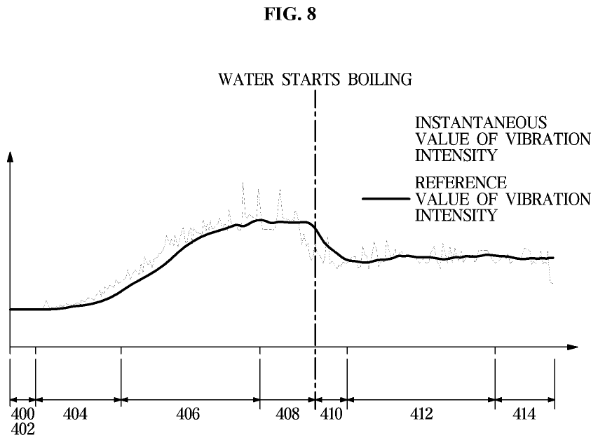

FIG. 8 is a graph illustrating a change in vibration intensity during a boiling process of water in a cooking vessel on an induction heater according to an embodiment.

Referring to FIG. 8, a horizontal axis represents time, and a vertical axis represents vibration intensity. On the horizontal axis, sections for the initial heating control stage (400), the correction data acquisition stage (402), the vessel heating detection stage (404), the maximum slope detection stage (406), the boiling candidate detection stage (408), the power level reduction and holding stage (410), the boiling confirmation stage (412), and the boiling control stage (414) are shown.

Data received from the vibration sensor 140 as boiling of water progresses may not be stable.

In the graph, a thin line represents a vibration intensity calculated at a corresponding point in time.

In the graph, a thick line represents a vibration intensity stabilized through a series of algorithms. The vibration intensity value represented as a thick line is defined as a reference value of vibration intensity.

The reference value of vibration intensity may be calculated by combining a moving average and a moving median.

As described above, assuming that FFT is performed once at a cycle of 250 ms, the reference value of vibration intensity is calculated using the FFT result as follows.

First, a sum of vibration intensities of each frequency band that is not excluded in the correction data acquisition stage (402) may be obtained. This value is referred to as P. This P may correspond to one point included in the thin line in the graph.

Then, P values for a recent defined period of time (e.g., 5 seconds) may be sorted. For example, 20 pieces of data based on a 250 ms cycle may be sorted.

An average of median values corresponding to a defined time (e.g., 3 seconds) may be obtained. This value may be a reference value. For example, an average of 12 median values based on a 250 ms cycle may be obtained.

In summary, a method of selecting median values as a range, rather than selecting only one, and using an average of the selected values may be used. By taking the average of partial median values, a stable vibration intensity may be obtained while excluding intermittent noise.

Referring back to FIG. 7, a method of calculating a slope of vibration intensity is described below.

The slope of vibration intensity may be consistently calculated throughout the water boiling detection algorithm, and may be one of the objects of comparison for stage transition.

This slope may represent a slope value of the thick line in the graph shown in FIG. 8.

The mathematical meaning of the slope is as follows. A positive slope indicates an increasing trend to the right, and a negative slope indicates a decreasing trend to the right. In a case where the slope is positive, a larger value indicates a steeper increase. In a case where the slope is negative, a smaller value indicates a steeper decrease. Accordingly, a trend of the graph may be determined based on the sign or value of the slope.

Because the data received from the vibration sensor 140 is not stable, the slope may be calculated over a defined period of time. A longer calculation time may lead to more accurate detection, but may reduce response speed, which indicates that although water is boiling, the reaction time to notify that water is boiling is delayed. However, a shorter calculation time may allow a boiling state to be reflected in real time, but may reduce accuracy. That is, it may be notified that water is boiling even though water is not boiling.

For the thick line, for example, data points may be generated at a cycle of 250 ms. An average slope may be calculated by collecting a defined number of recent data points. For example, in a case where a time interval is set to 5 seconds, a straight line representing the 20 most recent points is drawn, and a slope of the straight line may be used as a result value.

Intervals may be set differently according to the stages of the algorithm. Slope calculation intervals according to each stage are as follows.

For example, in the vessel heating detection stage (404), the maximum slope detection stage (406), the power level reduction and holding stage (410), a slope may be calculated over 5 seconds.

In the boiling candidate detection stage (408), a slope may be calculated over 3 seconds.

Because the boiling candidate detection stage (408) is a process of detecting candidates rather than confirming water boiling, quick candidate detection is required. When selected as a candidate for water boiling, temporarily lowering the power level may be performed in the subsequent stage. Quick candidate detection may enable rapid reaction to water boiling. However, because state determination accuracy may be lowered, it may proceed to a stage of lowering the power level even when water is not boiling, and thus, it may take longer to detect water boiling. On the other hand, a longer candidate detection time may cause a delay in the reaction to water boiling. However, because state determination accuracy is increased, it may not proceed to the stage of lowering the power level. As a result, the time until water boils may be shortened.

In the boiling confirmation stage (412), a slope may be calculated over 25 seconds.

Because the boiling confirmation stage (412) is a process of determining whether water has definitely boiled, a slope calculated over a sufficiently long period of time may be used with a stabilization time. A shorter boiling confirmation time may lead to a shorter stabilization maintenance time, and thus accuracy of determining whether water boils may be lowered. That is, even when water is already boiling, the power level may be set high again. Conversely, it may be determined that water is boiling even though water is not boiling. A longer boiling confirmation time may lead to a longer stabilization maintenance time, and thus, even when water actually boils, confirmation of the boiling state may be delayed.

Hereinafter, the vessel heating detection stage (404) is described in detail.

In the vessel heating detection stage (404), a power level is set to 9, i.e., water in the cooking vessel 10 may be heated at power level 9.

In order to detect that the cooking vessel 10 has become hot and evaporation of water has started, it may be confirmed whether a vibration intensity is greater than or equal to a vessel heating detection threshold.

The vessel heating detection threshold may be obtained by Equation [1] below.

Vessel heating detection threshold={number of valid frequency bands}×{average intensity of valid frequency bands}×{vessel heating detection coefficient}−Equation [1]

The number of valid frequency bands may be the number of frequency bands excluding the identified excluded frequency bands described in the correction data acquisition stage (402) from among all frequency bands. That is, the number of valid frequency bands may be the number of bands that are not excluded from among all frequency bands.

The average intensity of valid frequency bands may be an average of intensities of frequency bands that are not excluded as described in the correction data acquisition stage.

The vessel heating detection coefficient is a preset coefficient.

When a vessel heating detection condition is satisfied for a defined time, the controller 150 may determine that heating of the cooking vessel 10 is detected and may proceed to the maximum slope detection stage (406) which is a subsequent stage \textcircled{1}.

It may be confirmed whether the following three conditions are satisfied.

Condition 1) 1<{vibration intensity slope}

Condition 2) {vessel heating detection threshold}<{vibration intensity reference value}

Condition 3) Conditions 1 and 2 are continuously satisfied during a detection time

Condition 1 may indicate that a slope is an upward-sloping graph.

Condition 2 may indicate that an intensity of vibration is above a defined level compared to a correction point in time.

For example, in a case where the detection time is set to 5 seconds, the detection conditions are only required to be continuously satisfied for 5 seconds. Because detection is performed at a cycle of 250 ms, it will be 20 consecutive times. When one of the conditions is not satisfied, the counted number of times may be reset.

A shorter detection time may lead to a determination that the cooking vessel 10 is heated even when the cooking vessel 10 is not actually heated. In a case where the amount of water is significantly small, a longer detection time may stay in this stage even when water has almost boiled.

In order to improve the accuracy of the vessel heating detection stage (404), first, efficiency of the cooking vessel 10 may be applied to the vessel heating detection threshold. That is, a coefficient proportional to efficiency of the cooking vessel 10 may be applied.

In addition, in order to improve the accuracy of the vessel heating detection stage (404), a probabilistic approach may be used by varying intervals for obtaining a reference value and a slope. For example, a reference value (slope) may be calculated in various intervals of 1 second/3 seconds/5 seconds/7 seconds/9 seconds units, and one that received more votes may be used to determine a specific situation.

Meanwhile, in the vessel heating detection stage (404), whether an exception is detected may be confirmed.

In the vessel heating detection stage (404), there may be a case of heating water that has not been long after water boiled. In this case, because the cooking vessel 10 has been already heated and the water temperature is also 90 degrees or higher, water will boil immediately when the power level is set to 9.

Because the above case is not common, exceptions are required to be excluded in the vessel heating detection stage (404) which is first stage after heating water.

In the vessel heating detection stage (404), when the following conditions are satisfied for a defined time, it may be determined that water is already boiling and proceed to the boiling

### Control Stage (414) \textcircled{2}.

Condition 1) 1>{vibration intensity slope}

Condition 2) {vessel heating detection threshold}<{vibration intensity reference value}

Condition 3) The above conditions are satisfied for 3 consecutive seconds

Condition 1 may indicate that a slope is downward-sloping or maintaining a current state.

Condition 2 may indicate that an intensity of vibration is above a defined level compared to a correction point in time.

In summary, the above conditions may indicate a case where vibration is strong but does not become stronger or rather becomes weaker.

Hereinafter, the maximum slope detection stage (406) is described.

The maximum slope detection stage (406) is entered when it is confirmed in the vessel heating detection stage (404) that the cooking vessel 10 is being heated.

In the maximum slope detection stage (406), a high power level may be maintained. The power level may be set to 9.

In the process of heating water, vibration intensity may gradually increase. Then, at some point, the rise slows down, and this point in time may be confirmed, which is related to the slope of a vibration intensity graph, and thus this value may be used for confirmation.

In the maximum slope detection stage (406), whether a minimum condition for determining whether water is boiling is satisfied may be confirmed.

In the maximum slope detection stage (406), whether water is boiling is merely estimated from the slope. That is, it may not be guaranteed that the slope is at its peak while water boils. Because patterns in which the slope temporarily decreases frequently occur according to the type of the cooking vessel 10 and a physical flow of water, the estimation stage may be performed to improve the accuracy and reliability of the algorithm.

In the maximum slope detection stage (406), a state immediately before water boils is confirmed when the process of boiling water is divided into several stages.

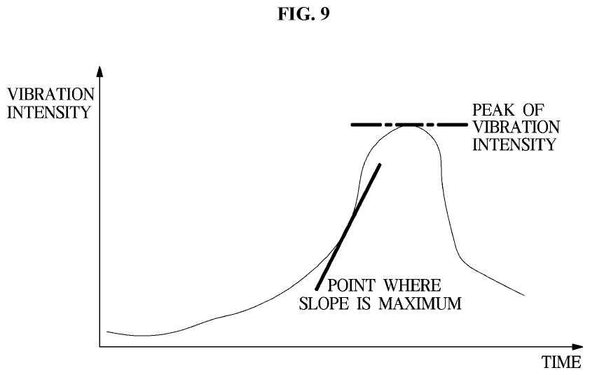

FIG. 9 is a graph illustrating an example of vibration intensity over time during a boiling process of water in a cooking vessel on an induction heater according to an embodiment.

Referring to FIG. 9, a horizontal axis represents time and vertical axis represents vibration intensity.

A graph of vibration intensity over time when an appropriate amount of water is contained in the cooking vessel 10 and heated to boiling is schematically shown.

As the water is heated, vibration intensity increases more rapidly. That is, a slope value of the vibration intensity increases. When water is heated to a certain extent, the rate of increase of vibration intensity gradually decreases and the vibration intensity reaches a peak. That is, the slope value gradually decreases and approaches 0.

In summary, the following criteria may be established. The slope is periodically calculated and updated whenever a new maximum slope value is detected. When a defined time (e.g., 5 seconds) has elapsed from the time when the maximum slope value was last updated, it may proceed to a subsequent stage, i.e., the boiling candidate detection stage (408) \textcircled{3}.

When the above criteria are satisfied, it may proceed to a subsequent stage, i.e., the boiling candidate detection stage, to confirm whether water is boiling (408).

However, in practice, there may be cooking vessels exhibiting unique vibration trends during water boiling, or variations in the amount of water may also occur.

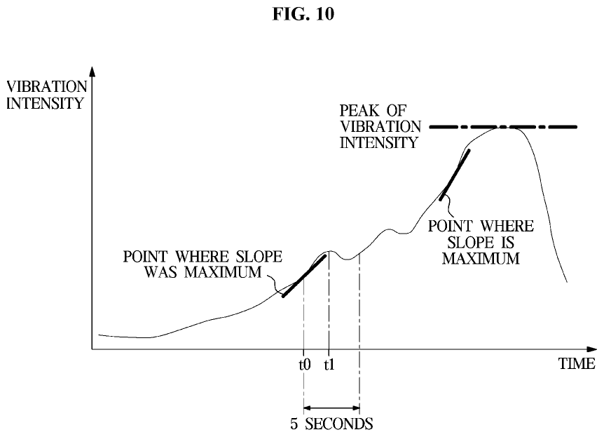

FIG. 10 is a graph illustrating another example of vibration intensity over time during a boiling process of water in a cooking vessel on an induction heater according to an embodiment.

Referring to FIG. 10, a graph illustrating an actual case that deviates from the criteria for a maximum slope value described above is shown.

In the maximum slope detection stage (406), when determination is made based only on the slope, because the vibration intensity does not increase uniformly, and may increase again over time, it may be determined at a point t1 that the water has been sufficiently heated even though the water has not even been sufficiently heated, and it may proceed to a subsequent stage.

In general, during a boiling process of water, a point at which boiling starts corresponds to a point at which the vibration intensity reaches a peak.

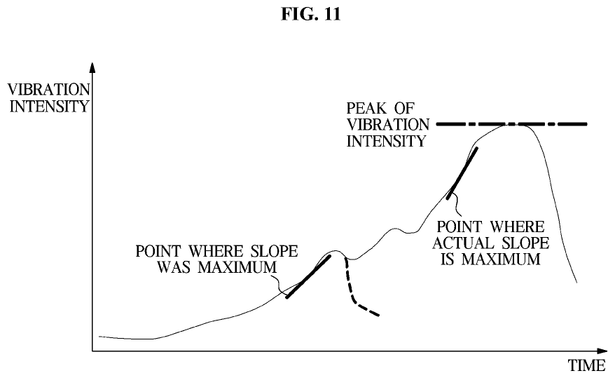

FIG. 11 is a graph illustrating still another example of vibration intensity over time during a boiling process of water in a cooking vessel on an induction heater according to an embodiment.

Referring to FIG. 11, although a point that appears to be a short-term peak may be detected based on a maximum slope value, it may not be easily determined whether this point is an actual boiling point or a temporary decrease, because whether the vibration intensity will follow a dotted line in the graph is not guaranteed.

Because the graph is observed over a full time range including a future, it may be seen that the vibration intensity eventually follows a solid line in the graph. However, in a process of drawing the graph in real time, the graph may be completed like the vibration intensity of a dotted line depending on the type of the cooking vessel 10 or the amount of water, and thus determination may not be easy.

In a case where the peak of vibration intensity is determined too quickly, accurate determination may not be made due to temporary decreases in vibration intensity of the dotted line. Conversely, in a case where the peak of vibration intensity is determined too slowly, a state in which water is boiling may be left for a long time.

Although quick and accurate determination of the peak of vibration intensity based on the maximum slope value in the maximum slope detection stage (406) may not be easily achieved, accuracy may be increased by introducing practical constraints.

Because accuracy is low when only the maximum slope value is used, a maximum value of vibration intensity may be additionally considered.

As the water is heated, the vibration intensity increases, and the vibration intensity also continues to increase.

Renewal of the peak of vibration intensity may occur more frequently than renewal of the peak of the slope.

Accordingly, the conditions may be supplemented by additionally considering renewal of the maximum value of vibration intensity.

The vibration intensity may be periodically calculated and updated whenever a new maximum vibration intensity value is detected. When a defined time (e.g., 4 seconds) has elapsed from the time when the maximum vibration intensity value was last updated, it may proceed to a subsequent stage, i.e., the boiling candidate detection stage (408).

However, adding this condition may improve the accuracy of determination in the maximum slope detection stage (406), but the boiling state may be left for a long time, because a point in time for lowering the power level is delayed even though water boils.

In order to compensate for such a state, an elapsed time may be adjusted. As described above, although a time condition for calculating the slope was a reference time (e.g., 5 seconds) from a last update point in time, in this stage, a response speed may be improved by shortening the reference time (e.g., 4 seconds).

In addition, a check logic may be implemented in the boiling candidate detection stage (408) which is the subsequent stage so as to allow a return to the maximum slope detection stage (406) \textcircled{4}. Under the assumption that a result determined in the maximum slope detection stage (406) is inaccurate, a logic for returning again in the subsequent stage may be added.

In summary, in the maximum slope detection stage (406), by combining theoretical background and supplementary matters, the slope may be periodically calculated and a remaining time may be updated to, for example, 5 seconds, whenever a new maximum slope value is detected. In a case where the remaining time is less than 4 seconds which is shorter than 5 seconds, it may be updated to 4 seconds. The remaining time decreases over time, and when the remaining time reaches 0, it may proceed to a subsequent stage, i.e., boiling candidate detection stage (408).

Meanwhile, in the maximum slope detection stage (406), an exception may be detected.

Under the assumption that the cooking vessel 10 has been sufficiently heated, the maximum slope detection stage (406) may be entered.

However, experimentally, an exception case of entering the stage even in cases where the cooking vessel has not been sufficiently heated may occur depending on the type of the cooking vessel 10.

In general, a pattern where the cooking vessel 10 itself generates large vibrations and then suddenly becomes quiet may occur at an early stage of boiling water.

In order to handle such an exception, it may be determined whether the cooking vessel 10 has not been sufficiently heated even in the maximum slope detection stage (406).

Based on determining that the cooking vessel 10 has not been sufficiently heated, it may return to the vessel heating detection stage (404) which is the immediately preceding stage \textcircled{5}.

Criteria for determining an exception are as follows.

{vessel heating detection threshold}>{vibration intensity reference value}

Based on the above condition being satisfied, it may immediately return to the preceding stage, i.e., vessel heating detection stage (404). Because it is determined that the current stage was entered erroneously, all maximum values calculated in this stage may be initialized.

Hereinafter, the boiling candidate detection stage (408) is described.

When the cooking vessel has been sufficiently heated and it is estimated that the graph will soon reach a local maximum value, the boiling candidate detection stage (408) may be entered. Here, the local maximum value may refer to a short-term peak followed by a decrease.

In the boiling candidate detection stage (408), a high power level may be maintained. The power level may be set to 9.

When water boils, the vibration intensity gradually decrease. Whether water has boiled may be confirmed based on this characteristic. Whether water boils may be determined based on the slope of the vibration intensity graph being a defined level or less.

In the boiling candidate detection stage (408), determining practical constraints, detecting a local maximum value, and detecting an exception may be performed.

First, determining practical constraints in the boiling candidate detection stage (408) is described.

The induction heater 1 may not identify the type of cooking vessel used by a user or the amount of water contained therein. Accordingly, even when a stage transition occurs, it may not be confirmed that the transition reflects an intention, and a discrepancy may exist between an assumed (intended) state and an actual state (reality).

When a local maximum value is detected in the boiling candidate detection stage (408), it may proceed to a subsequent stage, i.e., the power level reduction and holding stage (410) \textcircled{6}.

However, even though a local maximum value is detected, it may not be guaranteed that it is the highest point in a boiling process of water.

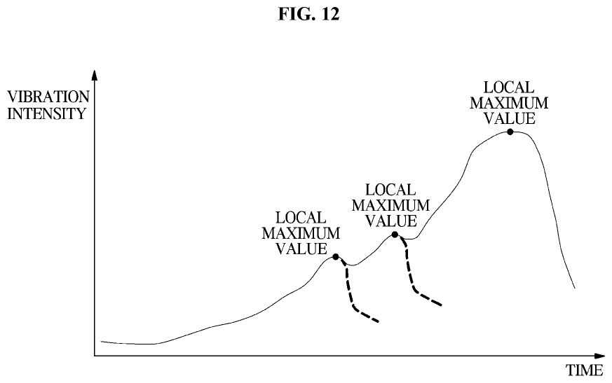

FIG. 12 is a graph illustrating a local maximum value of vibration intensity over time in a boiling process of food in a cooking vessel on an induction heater according to an embodiment.

Referring to FIG. 12, vibration intensity may follow a dotted line in the middle, not as a solid line.

Even though it proceeds to a subsequent stage, it may not be guaranteed that the water has boiled, and thus, the term “candidate” is used in the stage name. This estimation is finally confirmed in a subsequent stabilization stage, which will be described later.

Detecting a local maximum value in the boiling candidate detection stage (408) is described.

Mathematically, as a time value increases, when a positive slope gradually decreases and becomes negative, a value at which the slope becomes 0 is referred to as a local maximum value.

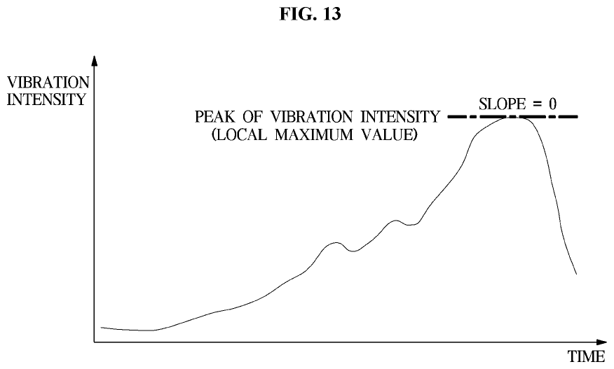

FIG. 13 is a graph illustrating an example of detecting a local maximum value of vibration intensity over time during a boiling process of water in a cooking vessel on an induction heater according to an embodiment.

Referring to FIG. 13, a local maximum value may be identified in the graph of vibration intensity.

The local maximum value may be identified by a point at which the slope of vibration intensity becomes 0.

However, such an ideal graph form does not generally appear during water boiling.

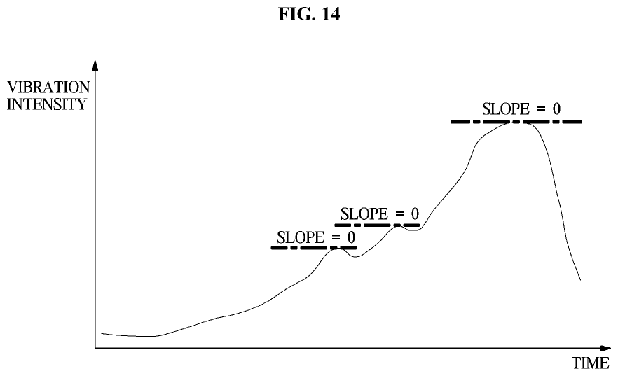

FIG. 14 is a graph illustrating another example of detecting a local maximum value of vibration intensity over time during a boiling process of water in a cooking vessel on an induction heater according to an embodiment.

Referring to FIG. 14, it is shown that sections with a slope of 0 frequently occur.

As described above, a slope is not calculated at a specific single point in time. The slope is obtained by fitting a straight line to data including values from a few seconds before a current time. Accordingly, even when the vibration intensity temporarily decreases, subsequent increase is shown, which may be partially filtered out.

However, it has been experimentally observed that, when water actually boils, the slope decreases significantly.

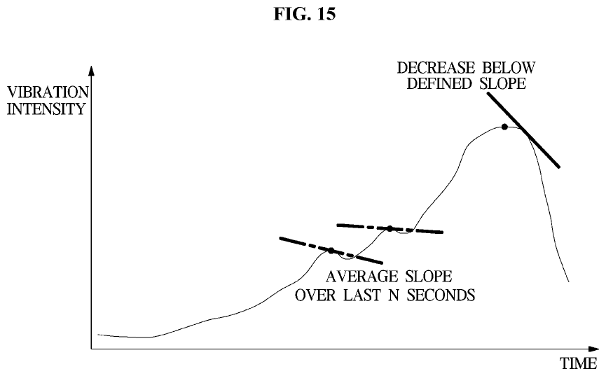

FIG. 15 is a graph illustrating still another example of detecting a local maximum value of vibration intensity over time during a boiling process of water in a cooking vessel on an induction heater according to an embodiment.

Referring to FIG. 15, accuracy may be further increased by using, as a determination criterion for the slope, a defined negative number less than or equal to 0, rather than 0.

Unless it is noise at a level where water boils and decreases, such noise may be filtered out to some extent. A smaller negative number may improve robustness against noise. However, it takes a long time to detect boiling, or boiling may not be detected.

Accordingly, setting a slope value is critical. In a case where a specific negative value is fixed, it may not operate properly for various patterns. Accordingly, the calculation may be performed by reflecting values that affect a falling range among values obtained in previous stages.

Thus, a slope drop detection threshold, which is a criterion for slope drop detection, may be obtained by Equation [2] below.

Slope drop detection threshold ={maximum slope value}×{number of valid frequency bands}×{slope drop detection coefficient} Equation [2]

The maximum slope value may be a maximum value of the slope calculated in the maximum slope detection stage (406). When the vibration intensity rises steeply, it may be expected that the vibration intensity decreases steeply.

The number of valid frequency bands may be the number of frequency bands that are not excluded.

The vibration intensity graph represents a sum of vibration intensities of each frequency band over time.

It may be expected that, as more frequency bands are excluded, the decrease becomes more gradual.

The slope drop detection coefficient is a preset coefficient.

A condition for finally detecting a local maximum value is as follows.

{slope}<{slope drop detection threshold}

When the above condition is satisfied for a preset number of times (e.g., once), it may proceed to a subsequent stage, i.e., the power level reduction and holding stage (410) \textcircled{6}.

Meanwhile, detecting a first exception in the boiling candidate detection stage (408) is described below.

Separately from detecting an inflection point, the same algorithm as performed in the maximum slope detection stage (406) may be applied, which is as follows. When a slope is calculated and the calculated slope is greater than the maximum slope value, it may return to the previous stage, i.e., the maximum slope detection stage (406) \textcircled{4}. When the vibration intensity is calculated and the calculated vibration intensity is greater than the maximum vibration intensity value, it may return to the previous stage, i.e., the maximum slope detection stage (406) \textcircled{4}. Here, the two maximum values to be referred to may be the maximum values calculated in the previous stage, and correspond to cases where a rapid rise pattern appears or the peak of vibration intensity is renewed before detecting the inflection point.

In addition, detecting a second exception in the boiling candidate detection stage (408) is described below.

There may be cases where this stage is entered even though the water is already boiling.

In this case, because the water is already boiling, the vibration intensity does not decrease sharply, and thus a local maximum value may not be detected. In addition, a local maximum value may not be detected by the first exception described above. In this stage, an exception for detecting whether water exhibits a boiling pattern may be added. For reference, it has been experimentally confirmed that, after water boils and a sufficient stabilization time passes, the slope converges to 0 or decreases moderately.

When the following conditions are satisfied, it may be determined that the second exception is detected.

{slope}<{water boiling confirmation slope}

The above condition is satisfied for 10 consecutive seconds.

Here, the water boiling confirmation slope may be a preset value.

When the second exception is detected in the boiling candidate detection stage (408), it may proceed to the boiling confirmation stage (412) \textcircled{7}.

The power level reduction and holding stage (410) is described below.

When it is estimated that water has boiled, the power level reduction and holding stage

### (410) May Be Entered \textcircled{6}.

In the power level reduction and holding stage (410), the power level may be lowered for a stabilization time. The power level may be set to 7.

Because water may not yet have boiled, the power level may be lowered and observed the state. In a case where water boils, because water boils too vigorously, the power level may be lowered and observed the state.

Also, data to be used for calculation in the boiling confirmation stage (412), which is the subsequent stage, may be obtained.

When the power level is lowered in the power level reduction and holding stage (410), the vibration intensity generally decreases. Accordingly, a stabilization time may be required.

Not only the physical flow of water contained in the cooking vessel 10 but also the reference value of vibration intensity and the vibration intensity slope are required to be stabilized, because these values are calculated using data over the past few seconds based on a current point in time. For example, a maintenance time for stabilization may be 15 seconds.

In the power level reduction and holding stage (410), a minimum value of the vibration intensity reference value may be calculated from a time at which entry into this stage begins. The minimum value may be used to determine whether water is boiling in the boiling confirmation stage (412) which is the subsequent stage.

After lowering the power level in the power level reduction and holding stage (410), when the maintenance time has elapsed, it may proceed to the boiling confirmation stage (412) \textcircled{8}.

Meanwhile, in the power level reduction and holding stage (410), an exception may be detected.

Entry into this stage is based on the premise that water has been sufficiently heated, and may include that the vibration intensity is not less than or equal to a defined value.

Because the patterns of vibration intensity are diverse, there may be cases where this stage is entered at an early stage of boiling water with a low probability. In general, such cases may occur due to a pattern in which the cooking vessel 10 itself generates large vibrations at an early stage of boiling and then suddenly becomes quiet.

In order to process such an exception, determining whether the cooking vessel 10 is not heated may be included in this stage.

When it is determined that the cooking vessel 10 is not heated, it may return to the

### Vessel Heating Detection Stage (404) \textcircled{9}.

Criteria for determining the above are as follows.

{vessel heating detection threshold}>{vibration intensity reference value}

When the above condition is satisfied, it may return to the vessel heating detection stage (404) \textcircled{9}.

Because it is determined that the current stage was entered erroneously, most data except for correction results may be initialized.

The boiling confirmation stage (412) is described below.

In the boiling confirmation stage (412), the power level may be maintained at 7.

It has been experimentally confirmed that when a boiling state is sufficiently stabilized, the vibration intensity maintains a current state or decreases moderately, which may correspond to a slope less than or equal to 0. However, the vibration intensity does not necessarily only decrease, and may remain at a certain level. That is, there are cases where the slope becomes 0 or more, but is low compared to the process of water boiling and does not significantly deviate from 0.

This stage may be entered even when water has not yet boiled, in which case an upward-sloping graph is observed. In this case, it may return to the vessel heating detection stage (404) \textcircled{11} or return to the maximum slope detection stage (406) \textcircled{12}.

In the boiling confirmation stage (412), immediately detecting water boiling, finally detecting water boiling over a sufficient time, and detecting an exception may be performed.

First, immediately detecting water boiling in the boiling confirmation stage (412) is described.

When a specific condition is satisfied, it may be immediately determined that water boils.

The characteristic that vibration intensity decreases moderately when water boils may be used. When the water has not boiled, the vibration intensity may maintain a current state or exhibit an increasing trend.

A sufficient stabilization time was taken in the power level reduction and holding stage (410) which is the previous stage, and a minimum point of vibration intensity was also calculated.

When the following condition is satisfied in the boiling confirmation stage (412), it may be immediately determined that water boiling has been successfully detected.

{vibration intensity}<{minimum vibration intensity value}

When the above condition is satisfied, it may be determined that boiling is immediately detected.

In addition, finally detecting water boiling over a sufficient time in the boiling confirmation stage (412) is described below.

When a sufficient time has elapsed, boiling may be finally determined. After entering this stage, for example, when 25 seconds pass, boiling is finally determined. This may serve as a final determination logic when no detection occurs in other parts of this stage. In a case where a time interval for calculating the slope of vibration intensity in the vessel heating detection stage (404) is set to 25 seconds, a final determination may be made when 25 seconds have passed after entering this stage in order to confirm the slope of a representative straight line for all vibration intensities generated over that period of time. Based on this slope value, boiling may be finally determined, and it may proceed to the boiling control stage (414). Otherwise, it may return to the heating detection stage (404) \textcircled{11} or return to the maximum slope detection stage (406) \textcircled{12}.

When the following condition is satisfied, it may be determined that water boiling has been successfully detected.

{slope}<{water boiling stabilization slope}

The slope may represent an average trend of vibration intensity corresponding to, for example, 25 seconds.

The water boiling stabilization slope is a preset coefficient.

When the above condition is not satisfied, it may return to the maximum slope

### Detection Stage (406) \textcircled{12}.

Meanwhile, detecting an exception in the boiling confirmation stage (412) is described below.

This is a case where this stage is entered in a state where water has not boiled. 0000

When the cooking vessel 10 is heated to some extent, vibration intensity increases, resulting in an upward trend. Whether an upward-sloping criterion is satisfied may be confirmed by referring to the maximum slope value calculated in the maximum slope detection stage (406). The maximum slope value is referenced because the power level is 7 in the boiling confirmation stage (412) which is the current stage, and the power level in the maximum slope detection stage (406) is 9. That is, because the slope was obtained based on power level 9, correction may be required to make the slope moderate.

A slope correction value may be obtained by Equation [3] below.

Slope correction value={maximum slope value}×{number of valid frequency bands}×{slope correction coefficient} Equation [3]

The maximum slope value may be the maximum slope value calculated in the previous maximum slope detection stage (406).

The number of valid frequency bands may be the number of frequency bands that are not excluded.

It may be expected that the more bands are excluded, the more moderately it will rise.

The slope correction coefficient may be a preset coefficient.

Based on the slope correction value, when the following condition is satisfied, it may immediately proceed to the maximum slope detection stage (406) \textcircled{12}.

{slope} >{slope correction value}

Satisfying this condition may indicate an upward trend.

The boiling control stage (414) is described below.

When water boiling is successfully detected, this stage may be entered.

In the boiling control stage (414), the power level may be lowered. The power level may be set to 5.

In addition, in the boiling control stage (414), the controller 150 may control the display 120 to display the boiling state and/or boiling progress of water in the cooking vessel 10 so that a user may check information about water boiling.

According to the disclosure, boiling of food contained in a cooking vessel may be detected more accurately and reliably regardless of the type of the cooking vessel.

According to an embodiment of the disclosure, an induction heater may include: a plate on which a cooking vessel is placed; a vibration sensor configured to detect vibration of the cooking vessel; a heating coil configured to heat the cooking vessel; and a controller configured to: increase a power level of the heating coil to heat food contained in the cooking vessel, obtain a first vibration pattern of the cooking vessel based on vibration data of the vibration sensor, based on the first vibration pattern satisfying a defined first condition, decrease the power level of the heating coil and maintain the decreased power level for a defined time, obtain a second vibration pattern of the cooking vessel after an elapse of the defined time, and determine that the food is in a boiling state based on the second vibration pattern satisfying a defined second condition.

The controller may be configured to obtain correction data from which vibration components generated by at least one of an inverter or a cooling fan of the induction heater are removed from the vibration data of the vibration sensor, and determine a vibration intensity and a vibration intensity slope based on the correction data.

The defined first condition may include at least one of a condition in which a slope of a vibration intensity of the first vibration pattern is maximum, or a condition in which a local maximum value of the vibration intensity is detected.

The condition in which the slope of the vibration intensity of the first vibration pattern is maximum may be determined based on a maximum slope value of the vibration intensity and a maximum value of the vibration intensity.

The condition in which the local maximum value of the vibration intensity is detected may include a condition in which the slope of the vibration intensity is less than a slope decrease detection threshold.

The defined first condition may include a vessel heating detection condition determined based on the slope of the vibration intensity and a vessel heating detection threshold.

The defined second condition may include a condition in which a vibration intensity of the second vibration pattern is maintained or decreases.

The defined second condition may include a vibration intensity of the second vibration pattern being less than a minimum value of vibration intensities while the power level of the heating coil is decreased and is maintained for the defined time.

The defined second condition may include a condition in which a slope of a vibration intensity of the second vibration pattern is less than a preset slope.

The food may be water.

The induction heater may further include a display, and the controller may be configured to control the display to display at least one of a boiling state or boiling progress of the food contained in the cooking vessel.

According to an embodiment of the disclosure, in a method for controlling an induction heater including a vibration sensor configured to detect vibration of a cooking vessel placed on a plate, and a heating coil configured to heat the cooking vessel, the method may include: increasing a power level of the heating coil to heat food contained in the cooking vessel; obtaining a first vibration pattern of the cooking vessel based on vibration data of the vibration sensor; based on the first vibration pattern satisfying a defined first condition, decreasing the power level of the heating coil and maintaining the decreased power level for a defined time; obtaining a second vibration pattern of the cooking vessel after an elapse of the defined time; and based on the second vibration pattern satisfying a defined second condition, determining that the food is in a boiling state.

The method may further include: obtaining correction data from which vibration components generated by at least one of an inverter or a cooling fan of the induction heater are removed from the vibration data of the vibration sensor, and determining a vibration intensity and a vibration intensity slope based on the correction data.

The defined first condition may include at least one of a condition in which a slope of a vibration intensity of the first vibration pattern is maximum, or a condition in which a local maximum value of the vibration intensity is detected.

The condition in which the slope of the vibration intensity of the first vibration pattern is maximum may be determined based on a maximum slope value of the vibration intensity and a maximum value of the vibration intensity.

The condition in which the local maximum value of the vibration intensity is detected may include a condition in which the slope of the vibration intensity is less than a slope decrease detection threshold.

The defined first condition may further include a vessel heating detection condition determined based on the slope of the vibration intensity and a vessel heating detection threshold.

The defined second condition may include a condition in which a vibration intensity of the second vibration pattern is maintained or decreases.

The defined second condition may include at least one of a condition in which a vibration intensity of the second vibration pattern is less than a minimum value of vibration intensities while the power level of the heating coil is decreased and is maintained for the defined time, or a condition in which a slope of a vibration intensity of the second vibration pattern is less than a preset slope.

The method may further include controlling a display to display at least one of a boiling state or boiling progress of the food contained in the cooking vessel.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium. The term ‘non-transitory storage medium’ may refer to a tangible device without including a signal (e.g., electromagnetic waves) and may not distinguish between storing data in the storage medium semi-permanently and temporarily. For example, the non-transitory storage medium may include a buffer that temporarily stores data.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. An induction heater, comprising:
a plate on which a cooking vessel is placeable;
a vibration sensor configured to detect vibration intensity of the cooking vessel while the cooking vessel is placed on the plate;
a heating coil configured to heat the cooking vessel; and
a controller configured to:
control the heating coil to heat the cooking vessel,
obtain a first vibration pattern of the cooking vessel based on vibration data obtained through the vibration sensor,
based on the first vibration pattern satisfying a first condition, decrease power level of the heating coil and maintain the decreased power level for a defined time,
obtain a second vibration pattern of the cooking vessel after the defined time lapses, and
based on the second vibration pattern satisfying a second condition, determine content of the cooking vessel is in a boiling state.

2. The induction heater of claim 1, wherein the controller is configured to obtain the first vibration pattern based on removing vibration components generated by at least one of an inverter or a cooling fan of the induction heater from the vibration data obtained through the vibration sensor.

3. The induction heater of claim 1, wherein the first condition comprises at least one of a change rate of the vibration intensity in the first vibration pattern being maximum, or the change rate of the vibration intensity being less than a threshold.

4. The induction heater of claim 3, wherein the controller is configured to determine that the change rate of the vibration intensity in the first vibration pattern is maximum, based on a maximum value of the change rate of the vibration intensity and a maximum value of the vibration intensity.

5. The induction heater of claim 3, wherein the threshold is 0.

6. The induction heater of claim 1, wherein the first condition includes a condition that the cooking vessel is heated over a threshold level.

7. The induction heater of claim 1, wherein the second condition comprises a condition that the vibration intensity of the second vibration pattern is maintained or decreased.

8. The induction heater of claim 1, wherein the second condition includes a condition that a vibration intensity in the second vibration pattern is less than a minimum value of vibration intensities obtained during the defined time after the power level of the heating coil is decreased.

9. The induction heater of claim 1, wherein the second condition comprises a condition that a change rate of the vibration intensity in the second vibration pattern is less than a threshold.

10. The induction heater of claim 1, wherein the content of the cooking vessel comprises water.

11. The induction heater of claim 1, further comprising:
a display;
wherein the controller is configured to control the display to display at least one of the boiling state or a boiling progress of the content of the cooking vessel.

12. A method of controlling an induction heater, the method comprising:
controlling a heating coil configured to heat a cooking vessel;
obtaining a first vibration pattern of the cooking vessel based on vibration data of the cooking vessel obtained through a vibration sensor configured to detect vibration intensity of the cooking vessel while the cooking vessel is placed on a plate of the induction heater;
based on the first vibration pattern satisfying a first condition, decreasing power level of the heating coil and maintaining the decreased power level for a defined time;
obtaining a second vibration pattern of the cooking vessel after the defined time lapses; and
based on the second vibration pattern satisfying a second condition, determining content of the cooking vessel is in a boiling state.

13. The method of claim 12, wherein the obtaining of the first vibration pattern comprises obtaining the first vibration pattern based on removing vibration components generated by at least one of an inverter or a cooling fan of the induction heater from the vibration data obtained through the vibration sensor.

14. The method of claim 12, wherein the first condition comprises at least one of a change rate of the vibration intensity in the first vibration pattern being maximum, or the change rate of the vibration intensity being less than a threshold.

15. The method of claim 14, further comprising determining that the change rate of the vibration intensity in the first vibration pattern is maximum, based on a maximum value of the change rate of the vibration intensity and a maximum value of the vibration intensity.

16. The method of claim 12, wherein the first condition includes a condition that the cooking vessel is heated over a threshold level.

17. The method of claim 12, wherein the second condition comprises a condition that the vibration intensity of the second vibration pattern is maintained or decreased.

18. The method of claim 12, wherein the second condition includes a condition that a vibration intensity in the second vibration pattern is less than a minimum value of vibration intensities obtained during the defined time after the power level of the heating coil is decreased.

19. The method of claim 12, wherein the second condition comprises a condition that a change rate of the vibration intensity in the second vibration pattern is less than a threshold.

20. A non-transitory computer-readable storage medium storing instructions that, when executed by a controller of an induction heater, cause the induction heater to perform operations comprising:
controlling a heating coil to heat a cooking vessel;
obtaining a first vibration pattern of the cooking vessel based on vibration data obtained through a vibration sensor configured to detect vibration intensity of the cooking vessel while the cooking vessel is placed on a plate of the induction heater;
based on the first vibration pattern satisfying a first condition, decreasing power level of the heating coil and maintaining the decreased power level for a defined time;
obtaining a second vibration pattern of the cooking vessel after the defined time lapses; and
based on the second vibration pattern satisfying a second condition, determining content of the cooking vessel is in a boiling state.
